(19) United States
(12) Patent Application Publication
(10) Pub. No.: US 2015/0045198 A1
(43) Pub. Date: Feb. 12, 2015

(54) METHOD AND APPARATUS FOR MICROFOLDING SHEET MATERIALS

(71) Applicant: Rutgers, The State University of New Jersey, New Brunswick, NJ (US)

(72) Inventors: Basily B. Basily, Piscataway, NJ (US); Elsayed A. Elsayed, East Brunswick, NJ (US)

(73) Assignee: Rutgers, The State University of New Jersey, New Brunswick, NJ (US)

(21) Appl. No.: 14/263,022

(22) Filed: Apr. 28, 2014

Related U.S. Application Data
(63) Continuation of application No. PCT/US2012/062347, filed on Oct. 28, 2012.
(60) Provisional application No. 61/628,331, filed on Oct. 28, 2011.

(51) Int. Cl. B31F 1/00

(52) U.S. Cl. CPC B31F 1/0019
USPC 493/454

(57) ABSTRACT

A folding machine for folding sheet material into microfolds. The folding machine has a first series of rollers that imparts longitudinal folds to the material. The machine has a second series of rollers where each succeeding roller has double the tessellations as the roller immediately before it. Moreover, the tessellation height of the second series diminishes by half which each succeeding roller. Material leaving the second series of rollers is then fed into a final set of rollers. The final set of rollers imparts a pattern geometry to the folded sheet material.

### RELATED APPLICATIONS

This application is a continuation of pending PCT Appl. Ser. No. PCT/US2012/062347 filed on Oct. 28, 2012, which claims the benefit of U.S. Provisional Appl. Ser. No. 61/628,331, filed Oct. 28, 2011, the contents of which are incorporated by reference herein.

### FIELD OF THE INVENTION

The present invention relates to the folding of sheet materials and, more particularly, to a method and apparatus for microfolding different types of sheet materials into a multiplicity of predetermined, three-dimensional structural patterns.

### BACKGROUND OF THE INVENTION

Folded materials are useful in packaging technology, sandwich structures, floor boards, car bumpers and other applications where requirements pertaining to shock, vibration, energy absorption, and/or a high strength-to-weight ratio including volume reduction must be met.

Continuous folding machines should have versatility, flexibility, and high production rates. U.S. Pat. Nos. 7,691,045 ('045) and 7,115,089 ('089), which are incorporated by reference herein disclose a continuous folding machine that achieves these objectives by first adding linear folds to a sheet of material and then subsequently imparting a three-dimensional shape to the linear folds.

However, prior systems, including the above-mentioned system, are not capable of folding materials at the micro scale level in an efficient and economical manner.

The invention set forth herein is directed to a novel folding machine and method for producing different patterns on a variety of materials at the micro scale level.

### SUMMARY OF THE INVENTION

The present invention is directed to a novel folding machine having a series of sets rollers where the number of pointed annular wedges of each roller set in the series is double than that of the preceding set of rollers. Moreover, each set of rollers in the series has a wedge height that is substantially half of the height of the preceding set. A final set of roller has the same number of wedges as the penultimate set, but rather than being a pointed wedge for imparting a fold—the final set of rollers are negatively engraved, etched or otherwise fromed with the pattern geometry to be imparted. The final set of rollers may be changed as desired to impart a variety of three-dimensional patterns.

In a general overview, the inventive machine performs two different pre-gathering steps before a three dimensional shape is imparted to the material.

First, the material is folded in a manner similar to that described in the '045 and '089 patents. Namely, the material is fed between a first set of rollers or dies, which makes a central single fold in the middle of the material. The material then advances to a second set of rollers or dies, that makes two extra outer folds, one on each side of the first fold. The material then advances to a third set of rollers or dies, making two additional outer folds. This process continues at the sequenced sets of rollers or dies until the desired number of folds in the rolling direction is reached. At the end of this first pre-gathering process, the material is folded with a series of even longitudinal folds. A cross section across the folded material has the appearance of a saw tooth pattern.

In the second pre-gathering step, the material is fed through a series of roller sets where each roller set has substantially double the number of wedges and which are substantially half of the wedge height of wedges in the immediately preceding set. In this second pre-gathering step, the number of folds substantially doubles and the height of each fold is decreased substantially by half in each serial pass through the roller sets. A cross section across the folded material after the second pre-gathering step has the appearance of a micro-scaled saw tooth pattern—with exponentially more teeth than the cross section after the first pre-gathering step.

In the final step, the material having longitudinal folds is fed through a set of dies which have a shape of a fold pattern formed thereon. The die imparts a folding pattern or shape on the pre-gathered material. The direction of the engraved folding pattern on the last set of rollers can be made longitudinal or perpendicular to the roller axis (or at any desirable angle in between), resulting in a longitudinal or cross-folded sheet. Further, the last set of rollers can be rubber on metal (one roller from rubber and the other from metal to create sharp increases in the folded pattern.

The innovative machine folds sheet material, including paper, biodegradable material, composites and plastics.

The inventive method and folding machine introduces new and highly economical method of producing micro-folded materials for lightweight cores, structures, and packaging materials. The material that is formed has many applications ranging from the design of diesel filters, to aviator crash helmets, to high-speed lighters, to airdrop cushioning systems, to biodegradable packaging materials and to lightweight floor decks, among others.

### BRIEF DESCRIPTION OF THE DRAWINGS

FIG. 1 shows a top view of a prior art machine for continuous folding of sheet materials.

FIG. 2 shows a side view of the machine of FIG. 1.

FIG. 3 shows a top view of a series of rollers for microfloding sheet material, also shown is a schematic view of material being microfolded according to an embodiment of the invention.

FIG. 4 shows an enlarged schematic view of a series of rollers used to microfold sheet material according to an embodiment of the invention.

FIG. 5 shows schematic cross-sectional views through folded materials at various stages of the microfolding process according to an embodiment of the invention.

FIG. 6 shows a perspective view of a set of shaping rollers according to an embodiment of the invention.

### DETAILED DESCRIPTION OF THE INVENTION

The following is a detailed description of the preferred embodiments of the invention, reference being made to the drawings in which the same reference numerals identify the same elements of structure in each of the several figures. It should be noted that these drawings are merely exemplary in nature and in no way serve to limit the scope of the invention, which is defined by the claims appearing herein below.

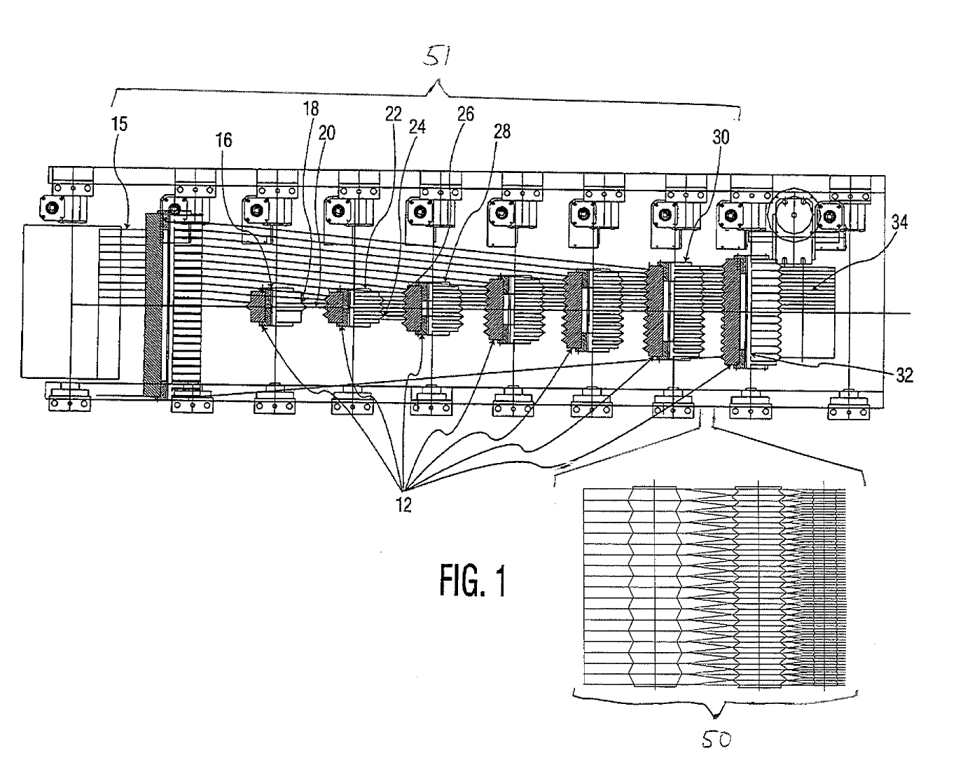

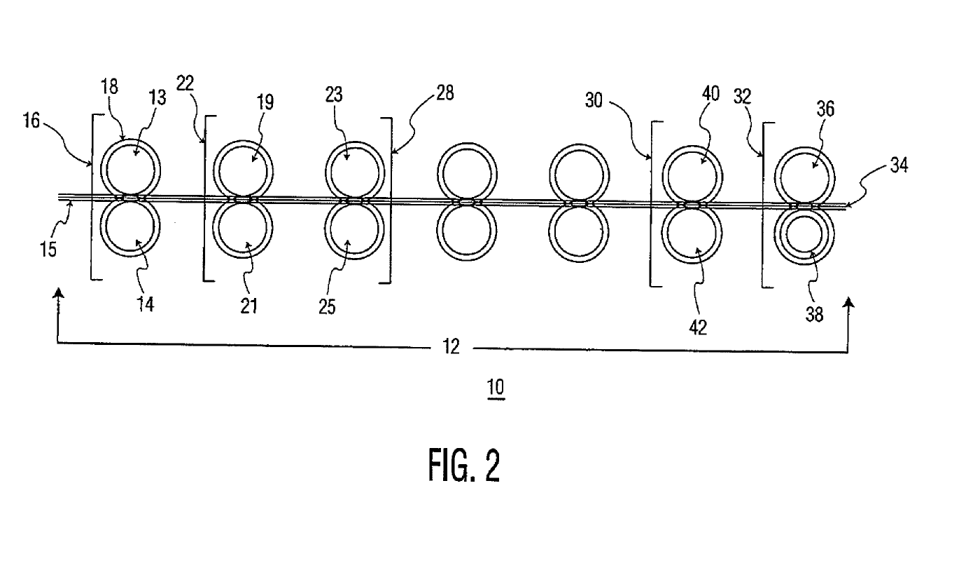

FIG. 1 shows a machine for continuous folding similar to that disclosed in the '045 and '089 patents. The machine for continuous folding 10 comprises a plurality of sets of rollers or dies 12. A set of rollers 12 comprises upper rollers and lower rollers, shown in FIG. 2. Each set of rollers, or dies 12 has a number of annular raised wedges or ridges 18 for folding sheet material 15. The raised ridges or wedges (sometimes “V” shaped) span the circumference of the roller. (The raised ridges or wedges that span the circumference of the rollers are alternatively referred to herein as “tessellations.”)

The sheet material 15 is fed through the first proximal set of rollers or dies 16. Each roller or die 13, 14 of the first proximal set of rollers or dies 16 has one tessellation 18. This tessellation 18 makes a single fold 20 in the sheet material 15.

Each roller or die 19, 21 of the second set of rollers or dies 22 has three tessellations for making an additional two folds in the sheet material 15. The single fold 20 produced by the first proximal set of rollers or dies 16 proceeds through the center tessellation of the second set of rollers or dies 22 where it maintains its shape. Two new folds 24, 26 are created by the outside tessellations of the second set of rollers or dies 22.

Each roller or die 23, 25 of the third set of rollers or dies 28 has five tessellations, two more tessellations 18 than each roller or die 19, 21 in the previous second set of rollers or dies 22. Seven sets of rollers or dies are depicted in FIG. 1, but the machine for continuous folding 10 can have any number of sets of rollers or dies depending on the desired width of the final folded structure. The number of tessellations 18 on each roller or die is determined from the mathematical series 1, 3, 5, 7, . . . , where each roller or die 13, 14 in the first proximal set of rollers or dies 16 has one tessellation 18, and each roller or die 19, 21 in the second set of rollers or dies 22 has three tessellations 18, etc.

In prior systems, this pattern of two additional tessellations 18 per roller or die continues from the first set of rollers or dies 16 to the penultimate set of rollers or dies (e.g. set 30 in FIG. 1) Each roller or die 36, 38 of the final set of rollers or dies 32 has the same number of tessellations 18 as each roller or die 40, 42 of the penultimate set of rollers or dies 30. The final fold pattern 34 is implemented by having the pattern geometry negatively engraved on the last set of rollers or dies 32.

In prior systems, once the sheet material has passed a sufficient number of rollers to introduce longitudinal folds to its entire width (e.g. after passing through roller set 30 in FIG. 1)—the material is then fed into a die which imparts a folding pattern or shape.

In the current invention, however, once longitudinal folds are made across the entire width of the material, a second pre-gathering operation is conducted to introduce microfolds to the material. The final folding pattern is imparted after the second pre-gathering step.

As shown in Fig. 1, the material leaving rollers 30 is not fed into the final shaping die. Rather, it is first fed through a series of microfolding rollers 50—before it is fed into the final shaping die. In the example set forth in FIG. 1, roller sets indicated by numeral 51 are the first set of rollers which perform the first pre-gathering step and rollers depicted by numeral 50 are the second set of rollers—which perform the second pre-gathering step. The second pre-gathering step produces microfolds.

As described, microfolding is achieved by way of a series of microfolding rollers. The microfloding rollers 50 have an upper and lower roller as described above—with the material passing therebetween. The first roller set of the microfolding rollers 50 have tessellations that are half of the height of the previous set and double the number of tessellations. This pattern of doubling the number of tessellations and reducing the height by half continues with each subsequent set of rollers in the microfolding series 50. With this arrangement, the height of the material that is fed through the first set of microfolding rollers achieves a reduction in the height (by half) and a doubling of longitudinal folds. The increase in folds and reduction in height continues with each passage through the set of microfolding rollers 50. (“Microfolding rollers” herein refer to a set of rollers that has more tessellation and therefore imparts more folds than a previous set of rollers and its fold height also is smaller than the previous set. Preferably, each roller set in a series of microfolding rollers have double the number of tessellations and they are one half the height of the previous roller set.)

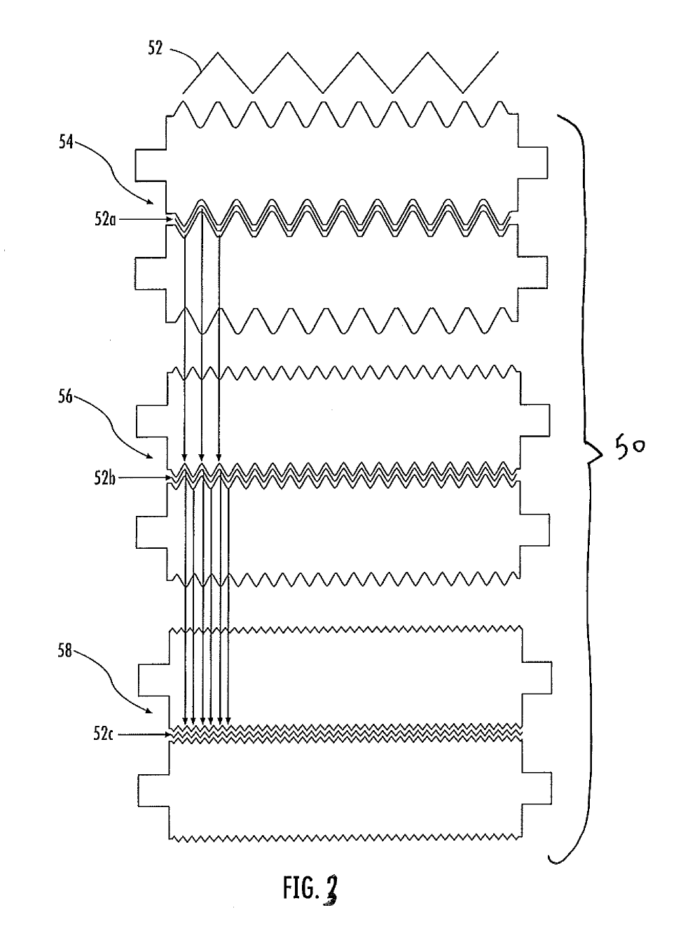

FIG. 3 shows an enlarged schematic view of a series of microfolding rollers 50. Material 52 leaving the first set of rollers (i.e. the first pre-gathering set 51) is fed into first roller set 54. Roller set 54 is provided with tessellations that are substantially half of the height of the folds on material 52 and there are double the number of tessellations on rollers 54 than there are folds in the material. As such, when material 52 is passed through roller set 54, roller set 54 will impart twice as many folds as material 52 previously had and it will decrease the height of the folds by half. As shown, sheet material 52a, leaving rollers 54 is reduced in height and it has double the number of folds as it had before being passed through rollers 54. A similar reduction of material 52b will occur as it passes through rollers 56 and 58 respectively.

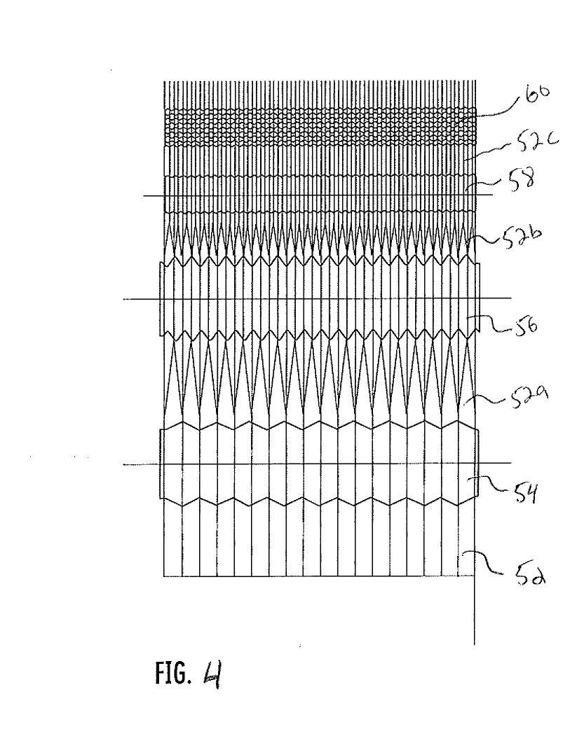

FIG. 4 shows a top schematic view of material being microfolded in a folding machine according to an embodiment of the invention. As shown, material 52 having been folded in a first pre-gathering step, is then fed through roller set 54. Roller set 54 is the first in a series of rollers that are used to microfold the material. As shown, material 52a leaving rollers 54 contains twice as many folds (and it is at half the height) as before it was passed through rollers 54. Roller set 56 contains twice as many and tessellations and at half the height of roller set 54—such that material 52b leaving roller set 56 contains twice as many folds and is at half the height as when it left rollers 54. The same is true for roller set 58 and any other microfolding rollers located thereafter.

Once a sufficient number of folds and a desired height is achieved (by passing the material through a selected number of microfolding rollers), the material is then fed through a final roller set. Final roll set 60, is engraved with a negative shape of a pattern to be imparted on the material. Roller 60 imparts the shape to each longitudinal microfold on the material.

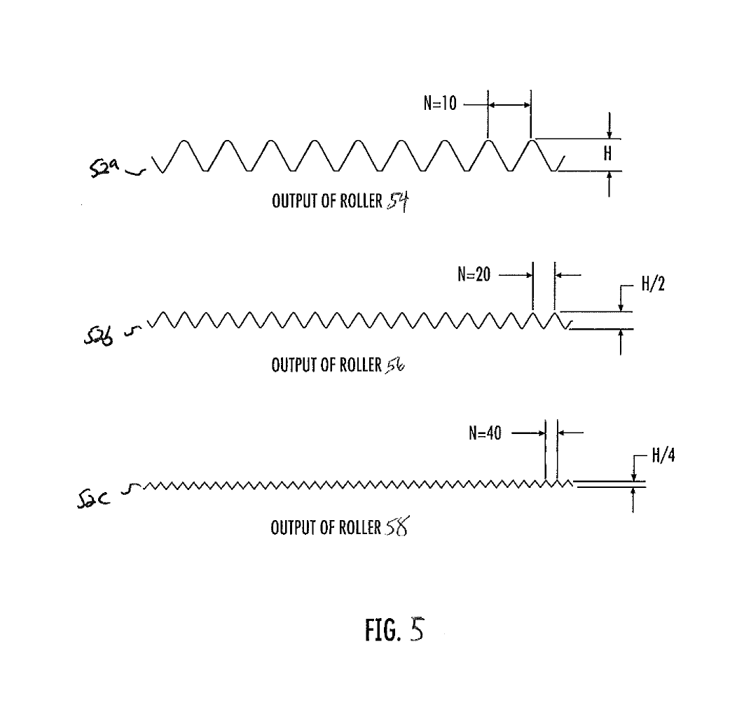

FIG. 5 shows cross-sectional views through the material in three different folding states corresponding to its state after passage through rollers 54, 56, and 58, respectively. As shown, after leaving rollers 54, material 52a has 10 folds at height “H.” After passage through rollers 56, material 52b has 20 folds at a height of half “H.” Similarly, after passage through rollers 58, material 52c has 40 folds at a height of a quarter “H.”

It will be understood by those of ordinary skill in the art that the serial reduction in the size of the microfolding rollers may be less than half and the number of folds could be less than double. For example, a second roller in a series of microfolding rollers may be provided with one and a half more tessellations than a previous roller. Moreover, the height reduction as between the first and second rollers may be 75% reduction or any other number. The inventive concept is not dependent on any particular number of tessellations or heights thereof—rather the invention relates to a serial diminution in the circumference of a series of rollers and a serial addition of tessellations for a set of rollers—such that with each pass through the roller set—the height of the material becomes decreased and the number of longitudinal folds are increased.

In an embodiment of the invention, the second pre-gathering step described herein generates material that has fold size (i.e. the distance between the longitudinal folds) ranging from around 0.0132 inches to around 0.25 inches. A fold pattern is imparted onto the folds.

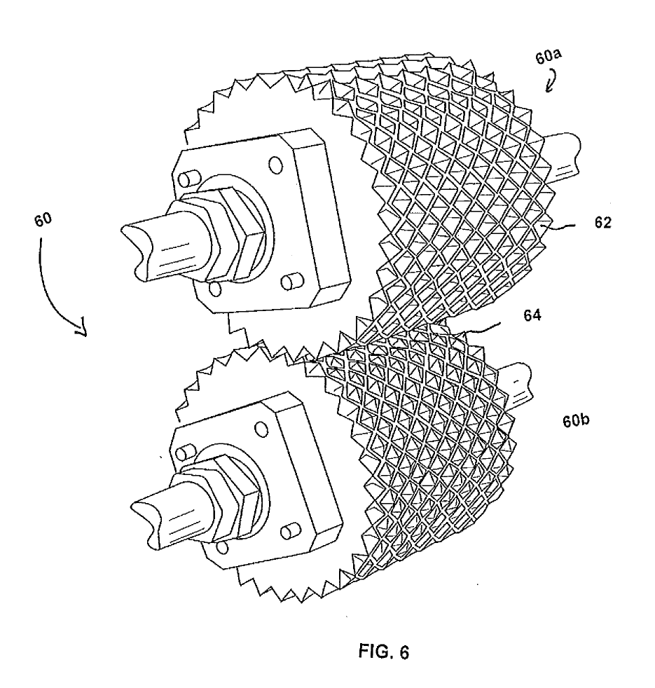

FIG. 6 shows an enlarged view of a set of shaping rollers 60 according to an embodiment of the invention. As shown, roller set 60 comprises a first roller 60a and a second roller 60b. The surface of first roller 60a contains negatively engraved patterns, whereas the surface of the second roller 60b contains the positive inverse of the patterns on the first roller 60a. In the example shown in FIG. 6, second roller has a series of outwardly projecting pyramid shaped teeth 64, whereas first roller 60a is provided with the negative contour 62 of the pyramid shapes. The pattern is repeated across each of the respective rollers 62a, 62b. It will be understood by those of ordinary skill in the art that any geometric patterns may be etched, engraved or otherwise formed on final rollers 60.

Preferably, the respective shapes are substantially sized to be the width of the folds in the material being fed through the shaping rollers.

It will be understood by those of ordinary skill in the art that the number of sets of microfolding rollers may change according to the degree of folding that is required. In the example described herein, a series of three sets of microfolding rollers are shown, but it will be understood that there may be more or less than three. Similarly, six set of rollers are shown in the first series of rollers (the first pre-gathering rollers)—more of fewer than six are possible as well.

Having described this invention with regard to specific embodiments, it is to be understood that the description is not meant as a limitation since further modifications and variations may be apparent or may suggest themselves to those skilled in the art. It is intended that the present application cover all such modifications and variation as fall within the scope of the appended claims.

What is claimed is:

1) An apparatus for folding sheet material, comprising:
a first series of rollers for creating longitudinal folds on said sheet material, said first series of rollers comprising a plurality of sets of rollers, each of said sets of said rollers comprising an upper roller and a lower roller, each of said rollers in said first series of rollers comprising tessellations, whereby the tessellations of said first set of rollers are substantially of equal height; and
a second series of rollers for folding said sheet material, said second series of rollers comprising a plurality of sets of rollers, each of said sets of said rollers comprising an upper roller and a lower roller, whereby each roller set in said second series of rollers comprises tessellations that are lower in height than tessellations on a preceding roller set.

2) The apparatus of claim 1, whereby each roller set in said second series of rollers comprises tessellations that are substantially half of the height of the tessellations on a preceding roller set.

3) The apparatus of claim 1, whereby each roller in each roller set of said second series of rollers comprises substantially double the tessellations as each roller in a preceding set of rollers.

4) The apparatus of claim 1, further comprising a final roller set, said final roller set comprising a series of geometric patterns formed thereon.

5) A method of folding sheet material, comprising the steps of:
providing a sheet material to be folded;
passing said sheet material through a first series of roller sets, said first series of roller set comprising a first roller set and a plurality of roller sets thereafter, said first set of rollers forming at least on longitudinal fold on said sheet material and each of said roller sets thereafter forming at least another two folds on said sheet material;
passing said sheet material through a second series of rollers, said second series of rollers comprising a first roller set and a plurality of rollers thereafter, whereby a fold height on said sheet material is diminished with each passage of said sheet material through each roller set of said second series of rollers.

6) The method of claim 5, whereby a number of folds on said sheet material is substantially doubled with each passage of said sheet material through each roller set of said second series of rollers.

7) The method of claim 5, whereby each roller of said first series and said second series of rollers comprises tessellations, whereby tessellations on each roller set of said second series of rollers are substantially half of the height of tessellations of rollers immediately preceding thereto.

8) The method of claim 5, whereby each of said sets of rollers comprises an upper and a lower roller.

9) The method of claim 8, whereby a number of tessellations said second series of rollers substantially doubles with each succeeding upper roller and lower roller.

10) The method of claim 5, further comprising the step of passing said sheet material through a final roller set, said final roller set comprising a series of geometric shapes formed thereon.
